(19) United States
(12) Patent Application Publication
(10) Pub. No.: US 2007/0084428 A1
(43) Pub. Date: Apr. 19, 2007

(54) Homogeneous charge compression ignition engine and method of operating

(75) Inventor: Lloyd E. Weaver, Harpswell, ME (US)

Correspondence Address: PATRICK R. SCANLON;PRETI FLAHERTY BELIVEAU & PACHIOS LLP, ONE CITY CENTER, PORTLAND, ME, 04112-9546, US

(73) Assignee: LEW Holdings, LLC

(21) Appl. No.: 11/282,019

(22) Filed: Nov. 17, 2005

Related U.S. Application Data
(60) Provisional application No. 60/728,142, filed on Oct. 18, 2005.
(60) Provisional application No. 60/728,528, filed on Oct. 20, 2005.

(51) Int. Cl. F02B 1/12; F02D 15/04; F02B 19/00; F02B 75/04

(52) U.S. Cl. 123/143 A; 123/48 D; 123/78 D

(57) ABSTRACT

An HCCI engine includes a power piston disposed in a cylinder and structure for increasing compression in the cylinder, independently of the power piston, so as to cause ignition of a fuel/air mixture in the cylinder. In one possible embodiment, compression is increased by firing a spring-loaded ignition piston positioned adjacent to the cylinder at the desired time. In another possible embodiment, compression is increased by generating a sound wave at the desired time.

### CROSS REFERENCES TO RELATED APPLICATIONS

This application claims the benefit of U.S. Provisional Application No. 60/728,142, filed Oct. 18, 2005 and U.S. Provisional Application No. 60/728,528, filed Oct. 20, 2005.

### BACKGROUND OF THE INVENTION

This invention relates generally to homogeneous charge compression ignition and more particularly to controlling ignition in homogeneous charge compression ignition engines.

A conventional gasoline engine (using the Otto cycle) intakes a mixture of gas and air, compresses the mixture, and then ignites the mixture with a spark. A diesel engine intakes and compresses air and then injects fuel into the compressed air. The relatively high temperature of the compressed air causes the fuel to spontaneously combust. Diesel engines generally have much higher compression ratios than gasoline engines, which lead to better efficiency. Because gasoline engines burn a homogeneous fuel/air mixture, they tend to have lower emissions.

Homogeneous charge compression ignition, or HCCI, is a combustion technology that combines characteristics of gasoline and diesel engines. An HCCI engine is a compression ignition (Cl) engine but without high pressure fuel injection to control when ignition takes place. With HCCI, fuel is injected with the intake stroke, just as with the Otto cycle, resulting in a homogeneous charge. Thus, HCCI exhibits the best of both worlds, Otto cycle low emission capability (especially low NOₓ) and diesel-like higher efficiency, but with lower temperature and leaner combustion than a diesel. HCCI ignition occurs more uniformly than a diesel within the compressed space since the fuel injected on the intake stroke has more time to achieve a homogeneous (gasified) condition before ignition. Thus, HCCI is an ideal internal combustion engine of the Cl type, achieving maximum pressure explosion within the cylinder but under leaner fuel and lower temperature conditions. HCCI has at least three significant advantages over diesel engines:
1. HCCI is capable of lean combustion which leads to higher efficiency and with comparable volatile organic compound (VOC) emissions with the Otto cycle and generally lower particulates than a diesel which are then filtered and VOCs removed in the exhaust system catalytic converters just as in an Otto cycle engine.
2. As noted, HCCI achieves high explosive pressures with a lean burn at lower combustion temperatures, maximizing efficiency. Lower average combustion temperature minimizes oxides of nitrogen smog pollutants well below that produced by the diesel cycle.
3. Like a diesel, HCCI has the ability to burn a wide range of heavy liquid fuels by virtue of its Cl process, including gasoline.

A problem with HCCI is controlling when ignition takes place; hence, this engine cycle is essentially not used today. In a gasoline engine, a spark is used to ignite the fuel/air mixture. In a diesel engine, combustion is initiated when the fuel is injected onto the hot, compressed air. With both engines, the timing of ignition can be precisely controlled. However, with current HCCI technology, there is no direct initiator of combustion; combustion begins when the appropriate temperature and pressure conditions are achieved. The process is thus inherently difficult to control.

Also, as in gasoline, sulfur is now being removed from diesel fuel to gasoline standards. So as society seeks to achieve greater fuel flexibility and efficiency using liquid fuels for transportation with low NOₓ pollution, perfecting the HCCI engine is becoming more important than ever. Yet, it's essential not to lower the power density of diesel engines, which the present invention preserves using the usual diesel technologies of high compression ratios, turbochargers, and modern injector systems.

Finally, an HCCI engine is capable of high efficiency. Because it has the ability to achieve high explosive pressures (efficiently converting fuel energy into pressure for conversion by the piston into mechanical energy at lowest combustion temperatures hence minimizing exhaust and cylinder heat losses), it would not be unreasonable for even truck sized engines at their higher rotating speeds (than stationary engine speeds) to reach around 50% efficiencies.

Accordingly, there is a need for a simple low cost way to precisely control when ignition takes place in HCCI engines, make HCCI comparable in cost and power density to a diesel engine, as well as provide a simple way to start the engine in a routine way with conventional diesel-like technology.

### SUMMARY OF THE INVENTION

The above-mentioned need is met by the present invention, which provides an engine having a power piston disposed in a cylinder and means for increasing compression in the cylinder, independently of the power piston, so as to cause ignition of a fuel/air mixture in the cylinder. The means for increasing compression can include an ignition piston positioned adjacent to the cylinder and means, such as a spring, for causing the ignition piston to move toward the power piston at any desired time. In one possible alternative, the means for increasing compression can include a device for generating a sound wave.

In one possible embodiment, the present invention is a homogeneous charge compression ignition engine having an engine housing, a first cylinder formed in the engine housing, and a second cylinder formed in the engine housing facing the first cylinder. A power piston is arranged to oscillate in the first cylinder between a top dead center position and a bottom dead center position, and an ignition piston is arranged to oscillate in the second cylinder between a first position and a second position. A firing mechanism is provided for causing the ignition piston to move from the first position to the second position at any desired time. The compression space defined between the power piston and the ignition piston becomes smaller in volume when the ignition piston is in the second position. Ideally, the smaller volume will be such that when the power piston is at or near top dead center, a fuel/air mixture therein will be compressed to the compression ignition point.

In another aspect, the present invention provides a method of operating an engine having at least one cylinder and a power piston arranged to oscillate in the cylinder between a top dead center position and a bottom dead center position. The method includes introducing a fuel/air mixture into the cylinder, and compressing the fuel/air mixture with the power piston. The fuel/air mixture is ignited when the power piston is at or near the top dead center position by further compressing the fuel/air mixture to a compression ignition point.

The present invention and its advantages over the prior art will be more readily understood upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a partial section view of an HCCI engine having a power piston at or near bottom dead center (BDC) and an ignition piston in its retracted position.

FIG. 2 is a partial section view of the HCCI engine having the power piston at or near top dead center (TDC) and the ignition piston still in its retracted position.

FIG. 3 is a partial section view of the HCCI engine having the power piston at or near top dead center (TDC) and the ignition piston in its extended position.

FIG. 4 is a side view of an alternative clamp arrangement for securing the piston rod of an ignition piston.

FIG. 5 is a partial section view of an HCCI engine having a device for generating a sound wave.

### DETAILED DESCRIPTION OF THE INVENTION

Ignition control and a simple way to start the engine are factors preventing widespread commercialization of HCCI engines. In accordance with one embodiment of the present invention, the ignition and timing problem is solved with the simple addition of a spring loaded ignition piston that when triggered springs forth to instantly reduce the compression space volume, and thus instantly increases compression to the ignition point for lean fuel mixtures. When the ignition piston trigger is pulled determines at what point near top dead center (TDC) position ignition occurs. For starting, standard glow plugs are used and the injector cycle may be temporarily shifted to a diesel cycle, but immediately after ignition piston latching, the next injector cycle switches to HCCI mode.

HCCI engine ignition control at or near TDC can be done in a practical way by varying compression ratio as noted. In one embodiment, this is accomplished by housing a much smaller ignition piston in a cavity within the cylinder head of the engine and then triggering a latch or clamp that releases the stored spring energy in the spring such that a higher, ignition compression ratio is achieved. In one embodiment, the increased ignition ratio can be 17:1, but higher or lower ignition ratios could be used depending on fuel type. The spring has enough extra force to counteract or meet the requirements of this pressure when the engine power piston is at or near TDC and maximum piston compression position. When the engine fires, the spring re-compresses to add the addition volume to reach a non-ignition state with a lower compression ratio for the next compression cycle. This energy is the same energy that would be used by the power piston to reach the higher compression ratio anyway (which in this instance is released or recovered in the next ignition sequence), so the only lost energy is spring internal friction energy, which is miniscule.

At the atmospheric cylinder pressure initial starting condition, the ignition piston and spring are likely fully extended into a recess cavity formed in the power piston. Upon turning over or starting the engine, the ignition piston spring compresses to near the higher compression point (TDC position for power and ignition pistons) whereby the fuel injector is programmed to recognize this unlatched ignition piston position as the diesel engine start condition and injects fuel on a diesel cycle basis starting the engine (a glow plug delay is initiated if cold temperatures so dictate). Immediately after latching due to ignition explosion on the diesel cycle, the injector controls switch over to the HCCI engine cycle whereby the fuel is injected on the intake stroke after exhaust with the ignition piston latched at the lower compression ratio state, whereby it is released at the next compression cycle triggering ignition using the ignition piston. The capability to trigger the ignition at any point in the compression portion of the cycle enables the engine to operate at maximum possible efficiency and be very lean burning and simplifies starting using a normal diesel cycle.

For a design example, consider an HCCI engine with a lower compression ratio of 12.5:1 (a mixture ignition would not likely take place at 12.5:1), and the small spring loaded ignition piston would be set to achieve a compressed volume of say 17:1 compression ratio. When released, the self-ignition compression ratio is reached and the cylinder fires. A 2-liter engine would normally have 4 cylinders at 500 CC each. At 12.5:1, each have compressed volume is 40 CC and compression pressure works out to about 188 psi (15×12.5, where atmospheric pressure is approximated at 15 psi). But at 17:1 the compressed volume would be 500/17 or 29.4 CC and a compression pressure of 255 psi. The power piston of the present invention would have a cavity that could accept the fully extended ignition piston such that at 255 psi, the ignition piston spring is, say, compressed such that the piston bottom surface is level with the inside head horizontal line (the spring is well attached to the piston inside surface and on the spring's other end to a backing plate). If the needed total pressure change was spread over 2.3 inches of ignition piston stroke, then the compression of the relaxed spring into the 17:1 ratio position would be 29.4/40×2.3 inches or 1.62 inches. The remaining spring compression to achieve the full 40 CC would be 2.3−1.62=.68 inches (0.68 inches for a 1″ area ignition piston corresponds to compression difference of about 11 CC which is about equal to the needed compression difference of 40−29.4 CC or 10.6 CC). The piston area to accomplish this compression difference is one inch square so the force on the piston at 29.4 CC is 255×1=255 pounds or a spring rate needed of 255/1.62 inches or 157 pounds/inch. The force at full 40 CC needed is 2.3×157 or 362 pounds. The work required to oscillate the ignition piston between 255 pounds and 362 pounds is (362−255)/2×0.68 inches or about 36 inch pounds, but this energy is recovered on the next ignition cycle. The only energy lost is in spring friction which makes a spring an ideal way to store ignition piston energy for the next cycle. Thus, the (recovered) power needed to operate the ignition cylinder spring on all 4 cylinders at 2200 rpm is 36×2200×4/12/33,000=0.8 horsepower. This is an approximately correct configuration, but perhaps a larger diameter ignition piston of shorter stroke would be selected, and even a slightly higher or lower spring rate than as calculated could be needed once development was completed. All the usual oil lubrication and water cooling details of this ignition piston in the head area would be provided such as a pressurized drip system for the ignition piston top area, or venting or piping the upper ignition piston space (not shown) to the oil pan might provide enough mist lubrication for the mechanisms in this space. In this way, all standard diesel components can be used including fuel injection, glow plugs for winter starting, and a turbocharger and/or supercharger to make a compact high power engine with all the advantages of HCCI.

The small ignition piston has a wide range in possible designs to initiate ignition. They can be larger diameter than shown and shorter stroked, or smaller in diameter and longer stroked, whichever yields the best combustion efficiency within the piston top space shown, and such combustion efficiency can only be determined by engine test and/or simulation. But generally, it's expected the compression space near the intake and exhaust valves will be very small, and the recess space at the top of the piston maximized. Failure of a valve drive means the piston will hit the valve, potentially ruining engine beyond repair. Thus, intake and exhaust valve drive means need to be reliable.

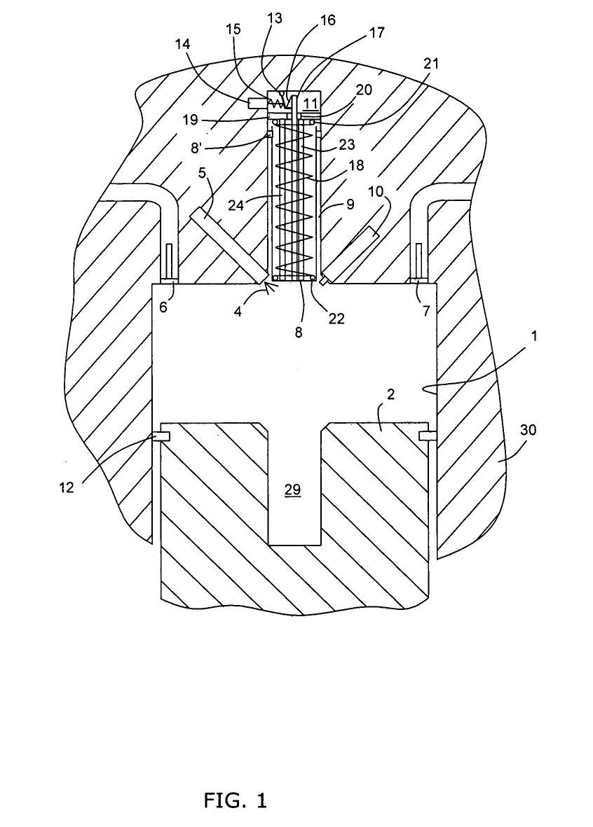

Referring now to the drawings wherein identical reference numerals denote the same elements throughout the various views, FIGS. 1-3 show an HCCI engine having an engine housing 30 with a power piston cylinder 1 and an ignition piston cylinder 9 formed therein. The ignition piston cylinder 9 is in communication with and facing the power piston cylinder 1. Although only one set of cylinders is shown in the Figures, it should be noted that the engine will typically include a plurality of such cylinder sets.

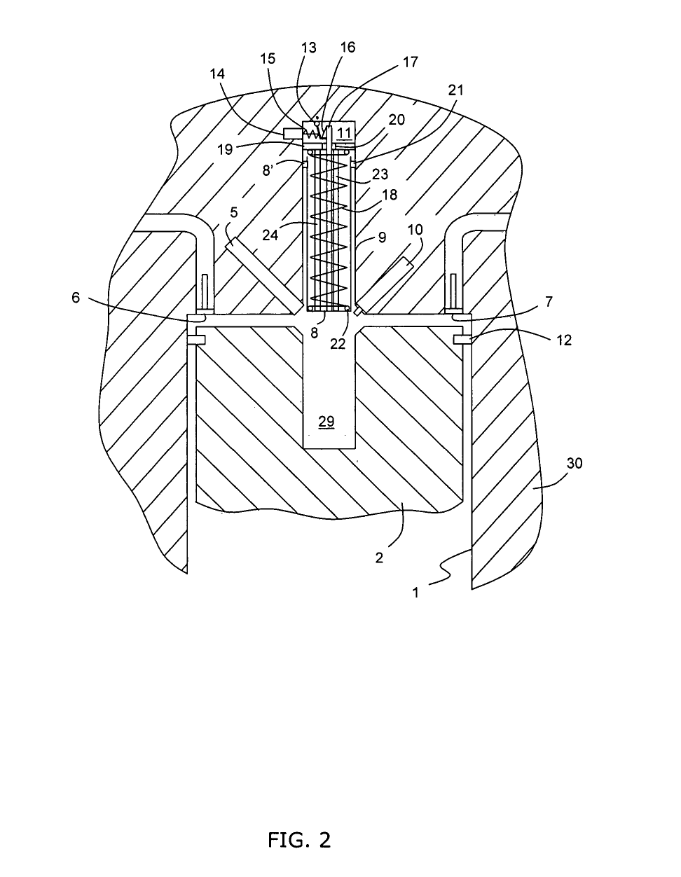

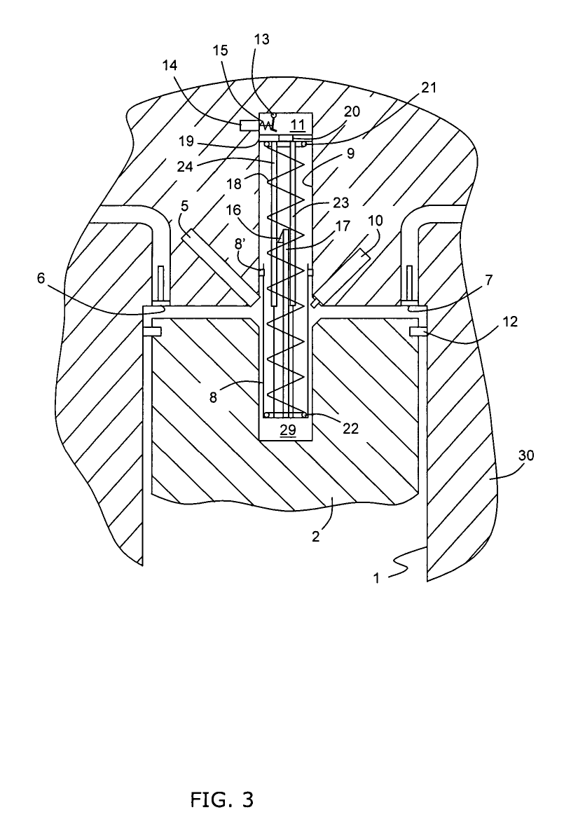

Water cooling of the power piston cylinder 1, the ignition piston cylinder 9, and the head area is not shown, but is typically provided for cooling these elements so as to avoid overheating. Piston cylinder 1 contains a reciprocating power piston 2 having a compression ring 12. Power piston 2 is shown in its bottom dead center (BDC) position in FIG. 1 and its top dead center (TDC) position in FIGS. 2 and 3. A cavity 29 is formed in the face of power piston 2. A fuel injector 5 is provided for injecting fuel 4 into the power piston cylinder 1. For HCCI operation, fuel 4 from injector 5 is sprayed in at the beginning of the intake stroke which lets in air though intake valve 6, the engine exhausts through exhaust valve 7. Glow plug 10 is available for starting if needed.

Ignition piston cylinder 9 contains a cylindrical ignition piston 8 having a compression ring 8′. The ignition piston 8 is arranged to oscillate in the cylinder 9 between a first or retracted position shown in FIGS. 1 and 2 and a second or extended position shown in FIG. 3, thereby moving toward and away from the power piston 2. It should be noted that while the face of ignition piston 8 is shown in FIGS. 1 and 2 as being slightly retraced with respect to the upper surface of cylinder 1, the ignition piston 8 is not so limited. Other starting positions, such as flush with the cylinder upper surface, are possible. The ignition piston 8 includes a cylindrical shell closed at its lower end and open at the upper end. A piston rod 17 is attached to the bottom face of the ignition piston 8 and extends upward beyond the cylindrical shell. When the ignition piston 8 is in the retracted position, the piston rod 17 extends through an opening 20 formed in a backing plate 19 that is fixed in the ignition piston cylinder 9, near the upper end. As shown, upper space 11 (i.e., the space in ignition piston cylinder 9 above the backing plate 19) has gases compressed and released by the oscillating action of ignition piston 8, this assists in the operation of ignition piston 8. Or, space 11 may be vented to the crankcase (via a line not shown). Lubrication flow into space 11 is not shown but would be applied as needed by those skilled in the art of designing lubricating systems. Generally, a pressurized drip system into space 11 would be satisfactory, or if vented to the crankcase, mists from there can lubricate the mechanisms of space 11. External surfaces of ignition piston 8 will be lubricated by the compressed air/fuel mixture with each cycle and by any leakage of space 11 lubrication by piston 8 compression ring 8′.

The engine further includes a firing mechanism for causing and controlling the motion of the ignition piston 8. In the illustrated embodiment, a spring 18 is disposed in the ignition piston 8, between the bottom face and the backing plate 19. The piston spring 18 preferably has ground end parallel surfaces perpendicular to its vertical axis so as to not cause any side-to-side force on ignition piston 8 when it is released. Ignition piston 8 also has retainers 21 attaching spring 18 to spring backing plate 19 and retainers 22 attaching the other end of spring 18 to the inside bottom face of ignition piston 8. Two shock absorbers 23 and 24 are provided in the ignition piston 8, extending between the piston bottom face and the backing plate 19, to prevent over compression of spring 18 when latching piston 8. A catch 16 is provided on the distal end of the piston rod 17 and is selectively engaged by a latch 13 that is pivotally mounted in the upper space 11 for securing or latching the ignition piston 8 in the retracted position against the bias of spring 18. An actuator 14 and a spring 15 are provided for controlling the latch 13.

Piston 8 is released by latch 13 via action of the actuator 14, which allows the spring 18 to force the ignition piston 8 towards the power piston 2 and into its extended position. The opening 20 enables catch 16 of piston rod 17 to pass through backing plate 19 when ignition piston 8 is triggered. When the ignition piston 8 returns to its retracted position due to combustion in the cylinder 2, the latch 13 latches onto catch 16 of piston rod 17 as the catch 16 passes by the spring loaded latch 13. Shock absorber 23 is preferably contiguous with the piston rod 17 so as to guide piston rod 17 when ignition piston 8 is oscillating. Furthermore, by simply making piston rod 17 and shock absorber 23 rectangular in shape, the contiguous arrangement will also prevent piston 8 and piston rod 17 from rotating. If the piston rod 17 were to rotate too much with respect to the latch 13, the catch 16 could not be latched. Since piston rod 17 is contiguous with shock absorber 23, which acts as a guide for 17, a friction brake substituted for latch 13 and spring 15 and operated by actuator 14 could accomplish the same momentary latching goal for piston 8.

The firing mechanism is triggered to cause the ignition piston 8 to move from its retracted position as shown in FIGS. 1 and 2 to its extended position as shown in FIG. 3. Preferably, the ignition piston 8 is fired when the power piston 2 is at or near TDC, as shown in FIG. 2. When released from its retracted position, the ignition piston 8 springs into the extended position of FIG. 3 where it is received in the cavity 29 of power piston 2. The ignition piston 8 thus instantly reduces the volume of the compression space defined between the power piston 2 and the ignition piston 8, thereby further compressing the fuel/air mixture (independently of the power piston 2) to its compression ignition point. The firing mechanism can be triggered at any desired time, thereby precisely controlling the timing of ignition. It should be noted that, because of variables such as slight variations in the composition of the fuel/air mixture, ignition will not necessarily occur at the exact same degree of ignition piston extension for every cycle. However, the timing of ignition will still be dependent on when the ignition piston 8 is fired.

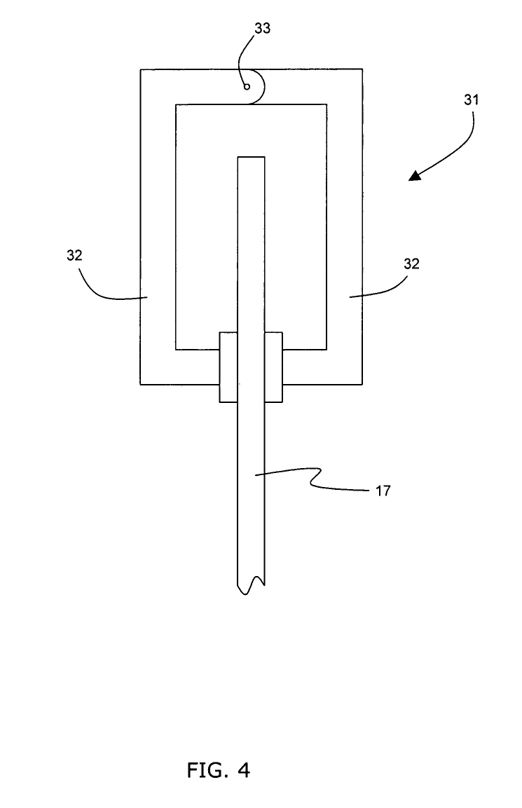

Alternative firing mechanisms are possible. For example, FIG. 4 shows a clamping arrangement that can be used instead of the latching mechanism of FIGS. 1-3. In this case, a fast-acting clamp 31 is provided for clamping and releasing the ignition piston rod 17. The clamp 31 comprises two opposing, C-shaped arms 32 that are pivotally connected together at pivot point 33. The arms 32 are operated by the actuator (not shown in FIG. 4) to open and close on the piston rod 17, thereby selectively releasing and clamping the piston rod 17. Unlike the latching mechanism described above, the clamp 31 is able to clamp the piston rod 17 at a range of positions along the length thereof. This provides the capability of adjusting the engine's compression ratio. For example, by using controllable hydraulic devices for the shock absorbers 23 and 24, the retracted position of the ignition piston 8 in the cylinder 9 could be adjusted, which would in turn adjust the position of the ignition piston 8 relative to the power piston 2 when the ignition piston 8 is fired into its extended position. This would therefore adjust the maximum compression ratio achieved when the ignition piston 8 is fired.

Another alternative firing mechanism includes a strong magnetic coil (not shown) that could be made part of ignition piston 8 or piston rod 17, which would hold ignition piston 8 in the upper position, and when ignition is required, the same electromagnet coil or extra coils would drive the piston 8, or a facsimile of piston 8, into its extended position to cause ignition. This represents more parasitic loss than that expended by flexing or cycling spring 18, and represents the full amount of electrical energy for ignition piston 8 displacement against air/fuel compressive forces unless electrical energy is recovered and released in the next ignition cycle by using a capacitor or such other storage means when explosion forces drive the piston 8 back to its usual latched position shown. Although a latch mechanism is not needed if magnetically driven, a shock absorber would preferably be included to stop ignition piston motion at the latch position.

Yet another alternative firing mechanism would include quickly pulsing air pressure up in space 11 simultaneously after releasing ignition piston 8 via latch 13 to force piston 8 to its ignition position (a light tensioning spring prevents the piston 8 from getting loose when the engine is stopped). While air pressure energy can be recovered by recompression of space 11 when piston 8 retracts by using the same combustion explosive force that retracts spring 18, this as well would use more energy than just cycling spring 18 and also requires boost compression means and control for each space 11 be part of the engine system. Thus, varying air pressure in space 11, or using a double acting cylinder for cycling piston 8 (not shown) would not be as efficient as a cycling spring 18, especially under high engine speed conditions. Unless a double acting cylinder is used to move piston 8, a latch mechanism and shock absorber is needed to arrest cylinder 8.

To start the engine, the face of piston 8 may be in its fully extended position, and intake valve 6 is opened to intake air. When ignition piston 8 is in its extended position, this position is known by the engine's timing controller since an electric position sensor that is part of actuator 14 (sensor not shown) detects if latch 13 (or a fast acting clamp device on rod 17) is not in latched position. In this condition or if there is no ignition firing initially, even if piston 8 is latched initially but then becomes unlatched so a “diesel start sequence” by injector 5 is indicated, after the starter motor is initiated and turns over the engine, compression pressure creates a force to compress spring 18 causing ignition piston 8 to retract into cylinder 9 into the retracted position, the 17:1 pressure ratio position when the power piston is TDC. At this point, the injector 5 fires fuel 4 as if it's a diesel cycle and the engine fires causing power piston 2 to move towards BDC, and the large pressure buildup after explosive ignition in now 17:1 ratio space 29 latches ignition piston 8. After combusted gases are exhausted through exhaust valve 7, intake valve 6 is opened, and the controller senses that the ignition piston 8 is latched. In response, the controller switches the injector 5 to inject fuel 4 on the next down or air intake stroke of power piston 2, and when intake valve 6 closes and piston 2 compresses the fuel/air mixture to the TDC area, the timing controller (not shown) triggers ignition piston 8 with a signal to actuator 14 and the engine is now running as an HCCI engine. If the engine fails to start, this cycle can be repeated as necessary. The controller will switch perfectly between starting the engine using injector 5 as a diesel cycle or injector 5 as an HCCI cycle as necessary.

Sizing of the ignition piston 8 and spring 18 was described above and basically involves calculating the volume difference at maximum compression for any given engine maximum displacement say between 12.5 compression ratio where ignition isn't likely to take place to 17:1 wherein it should definitely take place, but these design compression ratio values will vary depending on the fuel used.

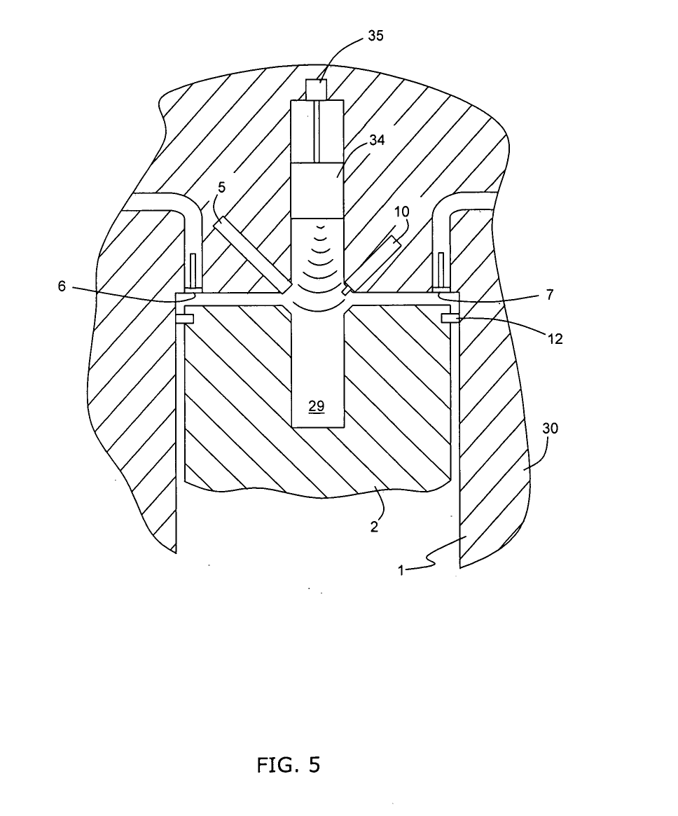

Referring now to FIG. 5, an alternative to using an ignition piston for increasing compression in the power piston cylinder 1, independently of the power piston 2, to cause ignition is illustrated. In this embodiment, a device 34 for generating a sound wave is mounted in the ignition piston cylinder 9 instead of an ignition piston. The sonic device 34 is operated by an actuator to blast a high energy sound shock wave on each needed ignition cycle from the fixed position (12.5 compression ratio in this example, or any lower compression ratio below compression ignition as noted previously) to create a compression wave effect in cavity 29 sufficient to raise the fuel-air mixture to compression ignition levels. The position of the sonic device 34 in the cylinder 9 could be adjusted via an actuator 35 in order to adjust the maximum compression ratio achieved when the sound wave is adjusted. This method might be less efficient than cycling spring 18 previously described, and such a shock wave device would need to be able to survive the intense environment inside the compression ignition space. But it does represent a plausible means to cause compression ignition with precise control over timing.

As mentioned previously, this engine can include other machine elements (not shown) common to diesel engines, which are not described in detail here. Such elements include engine controls for triggering ignition piston 8, a turbocharger, and fuel injector 5 that injects to create a lean fuel mixture to the intake manifold or glow plug 10. Also, the engine can be a two or four cycle HCCI engine by configuring it to a two cycle design and triggering ignition piston 8 twice as fast for a four cycle engine. It starts the same way as a 4-cycle engine, using the diesel cycle.

A conventional diesel engine power density is contemplated for the HCCI engine of this invention by use of diesel compression ratios, and savings using standard diesel components. This invention can also be configured to maximize engine power density consistent diesel practice while achieving the lean burning and efficiency gains and low NOₓ and lower emissions from the HCCI cycle.

While specific embodiments of the present invention have been described, it will be apparent to those skilled in the art that various modifications thereto can be made without departing from the spirit and scope of the invention as defined in the appended claims.

1. An engine comprising:
a cylinder;
a power piston disposed in said cylinder;
means for introducing a fuel/air mixture into said cylinder;
an ignition piston positioned adjacent to said cylinder;
a spring positioned to bias said ignition piston towards said power piston;
means for securing said ignition piston against said spring bias; and
an actuator for selectively releasing said means for securing said ignition piston, whereby said ignition piston moves toward said power piston to increase compression in said cylinder, independently of said power piston, so as to cause ignition of said fuel/air mixture.

2. (canceled)

3. (canceled)

4. The engine of claim 1 wherein said power piston has a cavity formed therein for receiving said ignition piston.

5. An engine comprising:
a cylinder;
a power piston disposed in said cylinder;
means for introducing a fuel/air mixture into said cylinder; and
a device for generating a sound wave for increasing compression in said cylinder, independently of said power piston, so as to cause ignition of said fuel/air mixture.

6. The engine of claim 5 further comprising means for adjusting the position of said device for generating a sound wave.

7. A homogeneous charge compression ignition engine comprising:
an engine housing;
a first cylinder formed in said engine housing;
a second cylinder formed in said engine housing facing said first cylinder;
a power piston arranged to oscillate in said first cylinder between a top dead center position and a bottom dead center position;
an ignition piston arranged to oscillate in said second cylinder between a first position and a second position, wherein a compression space is defined between said power piston and said ignition piston, said compression space defining a first volume when said ignition piston is in said first position and a second volume when said ignition piston is in said second position, wherein said second volume is smaller than said first volume for any given position of said power piston;
a spring positioned to bias said ignition piston towards said second position;
means for securing said ignition piston in said first position; and
an actuator for selectively releasing said means for securing said ignition piston.

8. The homogeneous charge compression ignition engine of claim 7 wherein when said power piston is at or near said top dead center position and said ignition piston is in said second position said second volume is sized to compress a fuel/air mixture therein to a compression ignition point.

9. (canceled)

10. The homogeneous charge compression ignition engine of claim 7 wherein said spring is a compression spring attached at a first end to an internal surface of said ignition piston and at a second end to a fixed surface in said second cylinder.

11. The homogeneous charge compression ignition engine of claim 7 wherein said means for securing includes:
a piston rod attached to said ignition piston and having a catch formed thereon; and
a latch for engaging said catch, said latch being operated by said actuator to selectively engage or release said catch.

12. The homogeneous charge compression ignition engine of claim 7 wherein said means for securing includes:
a piston rod attached to said ignition piston; and
a clamp for clamping said piston rod, said clamp being operated by said actuator to selectively engage or release said piston rod.

13. The homogeneous charge compression ignition engine of claim 7 further comprising means for adjusting said first position of said ignition piston prior to firing.

14. The homogeneous charge compression ignition engine of claim 7 wherein said power piston has a cavity formed therein for receiving said ignition piston.

15. The homogeneous charge compression ignition engine of claim 7 further comprising a fuel injector mounted to inject fuel into said cylinder.

16. A method of operating an engine having at least one cylinder and a power piston arranged to oscillate in said cylinder between a top dead center position and a bottom dead center position, said method comprising:
introducing a fuel/air mixture into said cylinder;
compressing said fuel/air mixture with said power piston; and
igniting said fuel/air mixture when said power piston is at or near said top dead center position by further compressing said fuel/air mixture to a compression ignition point using a spring-loaded ignition piston located adjacent to said cylinder.

17. (canceled)

18. A method of operating an engine having at least one cylinder and a power piston arranged to oscillate in said cylinder between a top dead center position and a bottom dead center position, said method comprising:
introducing a fuel/air mixture into said cylinder;
compressing said fuel/air mixture with said power piston; and
igniting said fuel/air mixture when said power piston is at or near said top dead center position by further compressing said fuel/air mixture to a compression ignition point using a sound wave.

19. The method of claim 16 wherein introducing a fuel/air mixture into said cylinder includes injecting fuel into said cylinder during an intake stroke in which said power piston is moving from said top dead center position to said bottom dead center position.

20. The method of claim 16 further comprising starting said engine by injecting fuel into compressed air in said cylinder when said power piston is at or near said top dead center position.

21. The method of claim 18 wherein introducing a fuel/air mixture into said cylinder includes injecting fuel into said cylinder during an intake stroke in which said power piston is moving from said top dead center position to said bottom dead center position.

22. The method of claim 18 further comprising starting said engine by injecting fuel into compressed air in said cylinder when said power piston is at or near said top dead center position.
